(19) United States
(12) Patent Application Publication
(10) Pub. No.: US 2008/0149841 A1
(43) Pub. Date: Jun. 26, 2008

(54) Light gathering apparatus

(76) Inventors: Theresa J. Sims, Los Altos, CA (US); Russell D. Schroder, San Jose, CA (US); Norman C. Franklin, San Jose, CA (US); Eric J. Earnst, Saratoga, CA (US)

Correspondence Address: Jennifer Hayes;BLAKELY, SOKOLOFF, TAYLOR & ZAFMAN LLP, Seventh Floor, 12400 Wilshire Boulevard, Los Angeles, CA, 90025, US

(21) Appl. No.: 11/644,512

(22) Filed: Dec. 22, 2006

(51) Int. Cl. G01J 1/04; G02B 6/26

(52) U.S. Cl. 250/368; 385/31; 250/227.11; 264/1.25

(57) ABSTRACT

Devices, systems and methods for radiation treatment are disclosed herein. The device may include a light gathering element having an outer surface, a portion of the outer surface of the light gathering element being substantially omni-directional. A portion of the outer surface of light gathering element is coupled to an optical fiber at substantially the base of the optical fiber. The device may include a cartridge having an opening therein for receiving the optical fiber, the light gathering element positioned at an end of the cartridge. A detector, coupled with the optical fiber, may be in the cartridge.

### TECHNICAL FIELD

This invention relates to the field of radiation treatment delivery systems and, in particular, to systems and methods for radiation detection.

### BACKGROUND

In radiosurgery or radiotherapy (collectively referred to as radiation treatment) very intense and precisely collimated doses of radiation are delivered to a target region in the body of a patient in order to treat or destroy lesions. Typically, the target region consists of a volume of tumorous tissue. Radiation treatment requires an extremely accurate spatial localization of the targeted lesions. Radiation treatment offers apparent advantages over conventional surgery, during which a surgeon's scalpel removes the lesion, by avoiding the common risks and problems associated with open surgery. These problems include invasiveness, high costs, the need for in-hospital stays and general anesthesia, and complications associated with post-operative recovery. When a lesion is located close to critical organs, nerves, or arteries, the risks of conventional surgery are even greater.

Radiation treatment requires a high precision diagnosis and high precision radiation source control. Quality assurance mechanisms are used prior to and, sometimes, during treatment to ensure proper alignment and configuration of the system prior to and during delivery of a prescribed radiation dose to a patient. One such quality assurance mechanism is an iso-post which is typically located near the center of the imaging system. The iso-post 10, as shown in FIG. 1A of the accompanying drawings, includes an iso-crystal 12 at an end of the iso-post. A fiber 14 runs through the iso-post 10 from the iso-crystal 12 to an electronic processing system 16, which includes a detector 18. The iso-post 10 is a support that positions the iso-crystal 12 at an imaging center of the image guidance system of the radiation treatment system. The fiber 14 transmits scattered light from the iso-crystal 12 to the detector 18 in the electronic processing system 16 for analysis.

The iso-crystal 12, shown in more detail in FIG. 1B, is manufactured by manually depositing a mixture of glue and glass beads around the end of the optical fiber 14. The iso-crystal 12 extends down a portion of the end of the fiber 14. The iso-crystal 12 of the prior art design typically has a diameter of about 2 mm formed around the end of the fiber 14.

It is also desirable for the iso-crystal 12 to have a spherical shape; however, it is difficult to mold the glue and bead mixture to have a spherical shape—the resulting iso-crystal 12 often has a tear-drop shape.

In addition, the gathering angle α of the fiber 14 is limited in the illustrated design because the iso-crystal 12 must be formed around the end of the fiber 14. The gathering angle α of the fiber 14 of the prior art design is typically at most 60°.

In conventional systems, if the iso-crystal or detector needs to be replaced, the entire iso-post typically must be replaced. It is also difficult to create multiple, uniform iso-crystals. Thus, the entire radiation system may need to be recalibrated when the iso-post is replaced. In addition, the limited gathering angle of the iso-crystal limits the amount and location of radiation that can be detected.

### BRIEF DESCRIPTION OF THE DRAWINGS

The invention is described by way of example with reference to the accompanying drawings, wherein:

FIG. 1A is a perspective view of an iso-post of prior art radiation treatment systems;

FIG. 1B is a schematic side view of an iso-crystal of prior art radiation treatment systems;

FIG. 2 is a perspective view of a radiation treatment delivery system in accordance with one embodiment of the invention;

FIG. 3 is a block diagram showing the relationship of components of a radiation treatment delivery system in accordance with one embodiment of the invention;

FIG. 4 is a detailed perspective view of an iso-post and imaging detectors of a radiation treatment delivery system in accordance with one embodiment of the invention;

FIG. 5 is a perspective view of an alternative radiation treatment delivery system in accordance with one embodiment of the invention;

FIG. 6 is a perspective view of an iso-post of a radiation treatment delivery system in accordance with one embodiment of the invention;

FIG. 7 is a perspective view of an iso-crystal holder of a radiation treatment delivery system in accordance with one embodiment of the invention;

FIG. 8 is a cross-sectional view of the iso-crystal holder of FIG. 7 in accordance with one embodiment of the invention;

FIG. 9A is a detailed perspective view of an iso-crystal of a radiation treatment delivery system in accordance with one embodiment of the invention;

FIG. 9B is a detailed cross-sectional view of an alternative iso-crystal of a radiation treatment delivery system in accordance with one embodiment of the invention;

FIG. 10 is a perspective view showing an iso-crystal and optical fiber of a radiation treatment delivery system in accordance with one embodiment of the invention;

FIG. 11 is a schematic side view of the iso-crystal of a radiation treatment delivery system in accordance with one embodiment of the invention;

FIG. 12 is a partial cross-sectional perspective view of a cartridge and holder of a radiation treatment delivery system in accordance with one embodiment of the invention;

FIG. 13 is a perspective view of an assembled cartridge and holder of a radiation treatment delivery system in accordance with one embodiment of the invention;

FIG. 14 is a perspective view of an assembled iso-post of a radiation treatment delivery system in accordance with one embodiment of the invention; and

FIG. 15 is a flow diagram showing a method of making a removable iso-crystal cartridge of a radiation treatment delivery system in accordance with one embodiment of the invention.

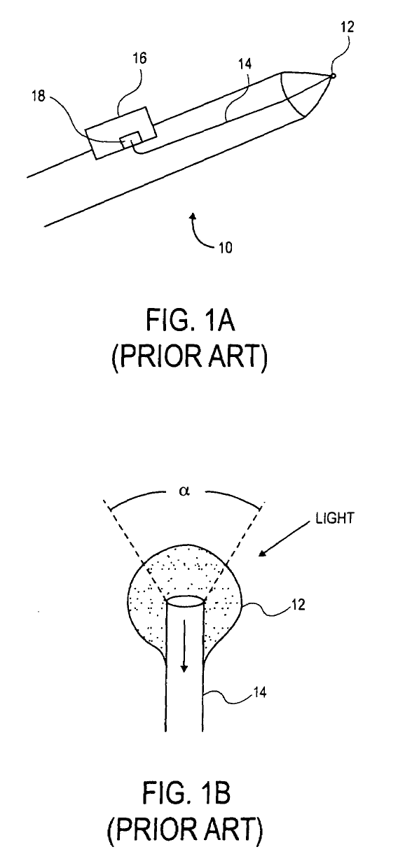

### DETAILED DESCRIPTION

Embodiments of systems, devices and methods for radiation treatment are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places through this specification are not necessarily all referring to the same embodiment. Furthermore, the particular features, structures, or characteristics may be combined in any suitable manner in one or more embodiments.

A light gathering apparatus for radiation treatment is disclosed herein. The light gathering apparatus may include a light gathering element having an outer surface, a portion of the outer surface of the light gathering element being substantially omni-directional. A portion of the outer surface of light gathering element is coupled to an optical fiber at substantially the base of the optical fiber. The light gathering apparatus may also include a cartridge having an opening therein for receiving the optical fiber, the light gathering element positioned at an end of the cartridge. A detector, coupled with the optical fiber, may be in the cartridge.

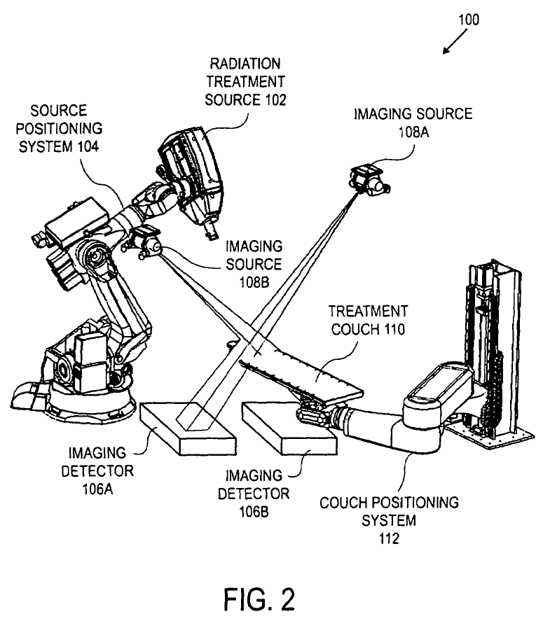

FIG. 2 is a perspective view of an image guided radiation treatment delivery system 100, in accordance with one embodiment of the invention. The illustrated embodiment of the radiation treatment delivery system 100 includes a radiation treatment source 102, a source positioning system 104, imaging detectors 106A and 106B (collectively 106, also referred to as imagers), imaging sources 108A and 108B, a treatment couch 110 and a couch positioning system 112.

System 100 may be used to perform radiotherapy or radiosurgery to treat or destroy lesions within a patient. During radiation treatment, the patient rests on treatment couch 110, which is maneuvered to position a volume of interest (“VOI”) within a patient to a preset position or within an operating range accessible to radiation treatment source 102 (e.g., field of view). Similarly, radiation treatment source 102 is maneuvered with multiple degrees of freedom (e.g., rotational and translation freedom) to one or more locations during delivery of a treatment plan. At each location, radiation treatment source 102 may deliver a dose of radiation as prescribed by a treatment plan.

Imaging sources 108 and imaging detectors 106 are part of an image guidance system that provides control over the position of treatment couch 110 and/or radiation treatment source 102 to position and align radiation treatment source 102 with the target VOI within the patient.

In one embodiment, radiation treatment delivery system 100 may be an image-guided, robotic-based radiation treatment system such as the CyberKnife® system developed by Accuray, Inc. in California. In FIG. 2, radiation treatment source 102 may be a linear accelerator (“LINAC”) mounted on the end of the source positioning system 104 (e.g., robotic arm) having multiple (e.g., 5 or more) degrees of freedom in order to position the LINAC to irradiate a pathological anatomy (target region or volume) with beams delivered from many angles in an operating volume (e.g., a sphere) around the patient. Treatment may involve beam paths with a single isocenter (point of convergence), multiple isocenters, or with a non-isocentric approach (i.e., the beams need only intersect with the pathological target volume and do not necessarily converge on a single point, or isocenter, within the target). Treatment can be delivered in either a single session (non-fraction) or in a small number of sessions (hypo-fractionation) as determined during treatment planning. With radiation treatment delivery system 100, in one embodiment, radiation beams may be delivered according to the treatment plan without fixing the patient to a rigid, external frame to register the intra-operative position of the target volume within the position of the target volume during the pre-operative treatment planning phase.

Imaging sources 108A and 108B and imaging detectors (imagers) 106A and 106B may form an imaging system. In one embodiment, imaging sources 108A and 108B are X-ray sources. In one embodiment, for example, two imaging sources 108A and 108B may be nominally aligned to project x-ray beams through a patient from two differing angular positions (e.g., separated by 90 degrees, 45 degrees, etc.) and aimed through the patient on treatment couch 110 toward respective detectors 106A and 106B. In another embodiment, a single large imager can be used that would be illuminated by each x-ray imaging source. Alternatively, other numbers and configurations of imaging sources and detectors may be used. The imaging detectors 106 are illustrated as being flat (i.e., parallel to the floor), but the imaging detectors 106 may, alternatively, be angled.

A digital processing system may implement algorithms to register images obtained from the imaging system with pre-operative treatment planning in order to align the patient on the treatment couch 110 with the radiation delivery system 100, and to precisely position the radiation treatment source 102 with respect to the target volume. Registration and alignment techniques are known in the art; accordingly, a detailed description is not provided.

In the illustrated embodiment, treatment couch 110 is coupled to a couch position system 112 (e.g., robotic couch arm) having multiple (e.g., 5 or more) degrees of freedom. Couch position system 112 may have five rotational degrees freedom and one substantially vertical, linear degree of freedom. Alternatively, couch positioning system 112 may have six rotational degrees of freedom and one substantially vertical, linear degree of freedom or at least four rotational degrees of freedom. Couch positioning system 112 may be vertically mounted to a column or wall, or horizontally mounted to a pedestal, floor or ceiling. Alternatively, the treatment couch 112 may be a component of another mechanical mechanism, such as the Axum™ treatment couch developed by Accuray, Inc. of California, or be another type of conventional treatment table known to those of ordinary skill in the art.

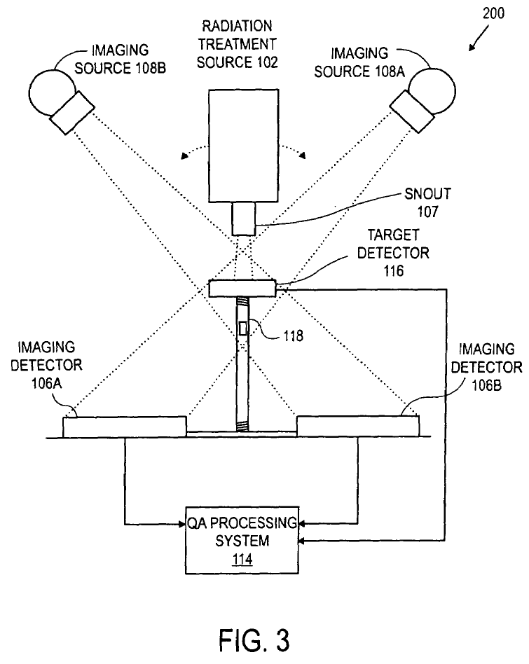

FIG. 3 is a block diagram illustrating the interrelationship of the components of the radiation treatment delivery system 100. The illustrated embodiment of the radiation treatment delivery system 100, as described above, includes a radiation treatment source 102, imaging detectors 106A and 106B, imaging sources 108A and 108B and treatment couch 110. Radiation treatment delivery system 100 further includes a quality assurance (“QA”) subsystem that includes a QA processing system 114, a target detector 116 and an iso-post 118.

Prior to delivery of the treatment plan to a patient, it is important to execute quality assurance (“QA”) mechanisms to ensure radiation treatment delivery system 100 is properly aligned and configured. These QA mechanisms, also referred to as confidence checks, validate the image guidance system, the couch positioning system, the source positioning system, and radiation treatment source 102, itself, which are all calibrated and aligned with each other. If anyone of these subsystems is misaligned with one or more other subsystems, a treatment plan could be erroneously delivered to a patient's detriment.

QA processing system 114 is communicatively coupled to target detector 116 (e.g., wired or wireless link) to receive QA data therefrom. QA processing system 114 may receive exposure images generated in response to a dose of radiation being delivered to target detector 116 from radiation treatment source 102. QA processing system 114 may then analyze the exposure images to determine whether radiation treatment delivery system 100 is aligned and calibrated. In one embodiment, target detector 116 may be implemented using the IMRTlog sensor from Cardinal Health, Inc. of Dublin, Ohio or the Mapcheck two dimensional detector by Sun Nuclear, Corp. of Melbourne, Fla. These detectors provide real-time feedback to QA processing system 114. Other radiation detecting equipment may be used as well. In one embodiment, QA processing system 114 may further be coupled to imaging detectors 108 to receive additional QA data therefrom.

QA processing system 114 may be a stand alone machine dedicated for QA analysis or integrated into other control systems of radiation treatment delivery system 100. Furthermore, although QA processing system 114 is illustrated as a single entity, it should be appreciated that FIG. 3 is a functional block diagram, and as such, QA processing system 114 may represent multiple distinct machines. QA processing system 114 represents an image processing system for analyzing exposure images and/or a dose processing system for analyzing a dose of radiation delivered by radiation treatment source 102.

Target detector 116 is stationed at a known, fixed reference point using the iso-post 118. In one embodiment, iso-post 118 is a rigid support that positions target detector 116 at an imaging iso-center of the image guidance system. Typically, the imaging iso-center is the location at which the x-ray beams from the x-ray sources intersect (i.e., a machine iso-center), where the patient is typically located during treatment. In one embodiment, the imaging geometry of the imaging system may provide two or more imaging centers. Multiple imaging centers may establish multiple treatment frames of reference and enable image-guided radiation treatment from above a patient and from below a patient.

It should be appreciated that any rigid support may be used to station target detector 116 at the known, fixed reference point. In one embodiment, target detector (and iso-post 118) may be incorporated into treatment couch 110 to validate the ability of the couch positioning system to accurately maneuver treatment couch 110. With target detector 116 positioned at the known, fixed reference point, it is possible to determine whether the image guidance system is aligned.

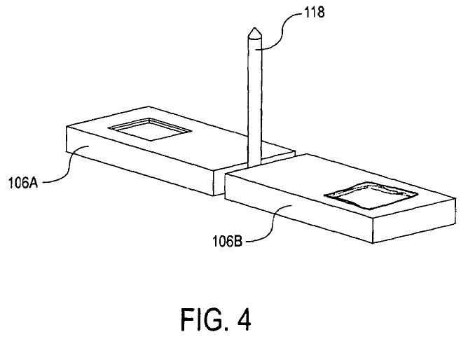

FIG. 4 is a detailed perspective view of the imaging detectors 106 and iso-post 118. The iso-post extends upward from the imaging detectors 106, such that the tip of the iso-post 118 is positioned at the imaging center of the guidance system. The iso-post 118 may be secured to the floor between the imaging detectors 106 or to a portion of the radiation treatment system 100 between the imaging detectors 106.

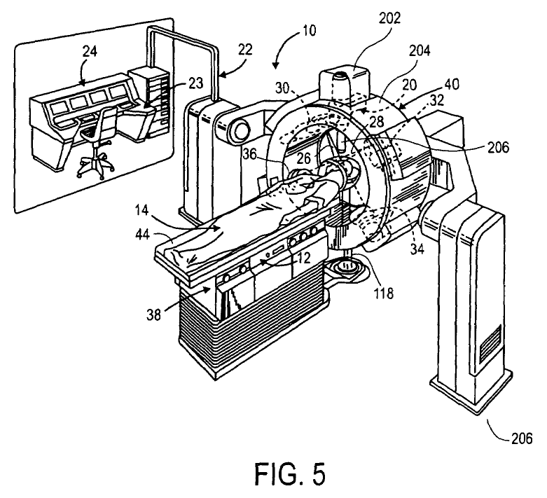

In one embodiment, the radiation treatment system may be another type of treatment delivery system, such as, for example, a gantry based (isocentric) intensity modulated radiotherapy (“IMRT”) system 200, as shown in FIG. 5. In a gantry based system 200, the therapeutic radiation source 202 (e.g., a LINAC) is mounted on the gantry 204 in such a way that it rotates in a plane corresponding to an axial slice of the patient. Radiation is then delivered from several positions on the circular plane of rotation. In IMRT, the shape of the radiation beam is defined by a multi-leaf collimator 206 that allows portions of the beam to be blocked, so that the remaining beam incident on the patient has a pre-defined shape. The resulting system generates arbitrarily shaped radiation beams that intersect each other at the isocenter to deliver a dose distribution to the target. In IMRT planning, the optimization algorithm selects subsets of the main beam and determines the amount of time that the patient should be exposed to each subset, so that the prescribed dose constraints are best met. The gantry-based system 200 may also include an iso-post 118 having a target detector 116 coupled to a QA processing system 114 to determine whether the gantry-based system 200 is aligned and calibrated.

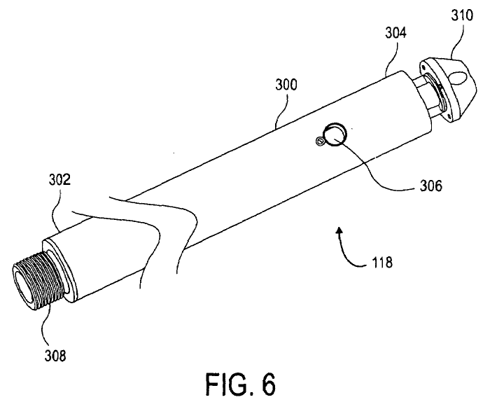

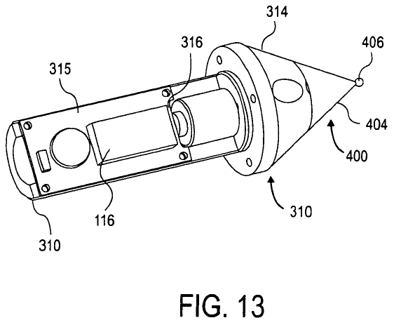

FIG. 6 is a perspective view illustrating the iso-post 118 in more detail. The iso-post 118 includes a shaft 300 having a first end 302, a second end 304, and a longitudinal opening (now shown) therein. The shaft 300 includes an opening 306 to communicatively couple the target detector 116, located in the iso-post 118, to the QA processing system 114. At the first end 302, a mount 308 may be provided to secure the iso-post 118 to the floor or the radiation treatment system 100 (or 200). At the second end 304, a cartridge 310 may be removably secured into the longitudinal opening of the shaft 300, as will be described hereinafter with reference to FIGS. 12-13.

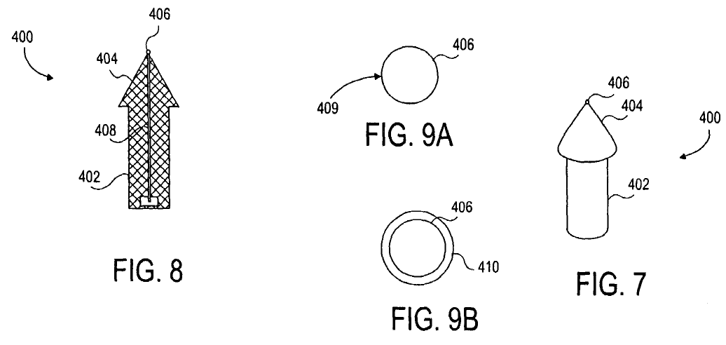

FIG. 7 is a side view of a holder 400 in accordance with one embodiment of the invention. The holder 400 includes a shaft 402, a conical tip 404 and an iso-crystal 406. As explained hereinafter, the iso-crystal 406 is a light gathering element that is coupled with the target detector 116.

FIG. 8 is a cross-sectional view of the holder 400. The holder 400 also includes an optical fiber 408 coupled with the iso-crystal 406 and running through the shaft 402 and the conical tip 404 of the holder 400. The iso-crystal 406 is coupled to the optical fiber 408 at substantially the base 410 of the optical fiber 408. In one embodiment, the iso-crystal 406 is coupled to the optical fiber 408 at the base 410. In one embodiment, a small portion of the end of the optical fiber 408 extends into the iso-crystal 406. For example, a portion of the optical fiber 408 that is less than approximately a diameter of the optical fiber 408 may extend into the iso-crystal 406 or a portion of the optical fiber 408 that is less than approximately 1% of the diameter of the fiber may extend into the iso-crystal 406.

FIGS. 9A and 9B are detailed views of the iso-crystal 406. The iso-crystal 406 is a light gathering element, which scatters light from the radiation source.

The iso-crystal 406 may be substantially spherical. In one embodiment, the iso-crystal 406 has a diameter on the order of 20-200 microns. In one embodiment, the iso-crystal 406 has a diameter of about 2 mm. Alternatively, iso-crystal 406 may have a diameter less than 2 mm or greater than 2 mm.

The light gathering element may be fabricated from materials such as polymethylmethacrylate (PMMA), polytetrafluoroethylene (also referred to as TEFLON® or PTFE), polymer, and the like. In an alternative embodiment, the iso-crystal 406 may be made from other materials such as ruby, or other similar materials selected to match the laser used for the radiation source 102. It should be noted that some materials such as PTFE have a light-scattering property.

In one embodiment, the iso-crystal has a light-scattering surface. The outer surface 409 of the iso-crystal 406 may be altered to have light-scattering surface properties. For example, the outer surface 409 of the iso-crystal 406 may be altered by roughening the outer surface. For example, PMMA's light scattering properties are not as effective as PTFE; however, by roughening the outer surface of a PMMA iso-crystal, the PMMA iso-crystal may become more light scattering. Other surface altering processes as known to those of skill in the art may be used to alter the outer surface 409 of the iso-crystal 406.

The light gathering element may include a dielectric coating 410, as shown in FIG. 9B. The dielectric coating 410 may be light reflecting. In one embodiment, the dielectric coating 410 is a dichroic coating. The dielectric coating 410 may be particularly effective with iso-crystals made from materials that have low light-scattering properties, such as, for example, PMMA. It will be appreciated that other light reflecting coatings or other dielectric coatings may be used with the iso-crystal 406.

In one embodiment, the light gathering element may include a wave length conversion material. The iso-crystal 405 and/or the dielectric coating 410 may include the wave length conversion material. In one embodiment, the wave length conversion material is a scintillating material. Exemplary scintillating materials include thallium-doped sodium iodide crystals, barium fluoride, cesium iodide, bismuth germinate, lanthanum bromide, lutetium iodide, phosphors, polystyrene, and the like. It will be appreciated that other wave length conversional materials may be used

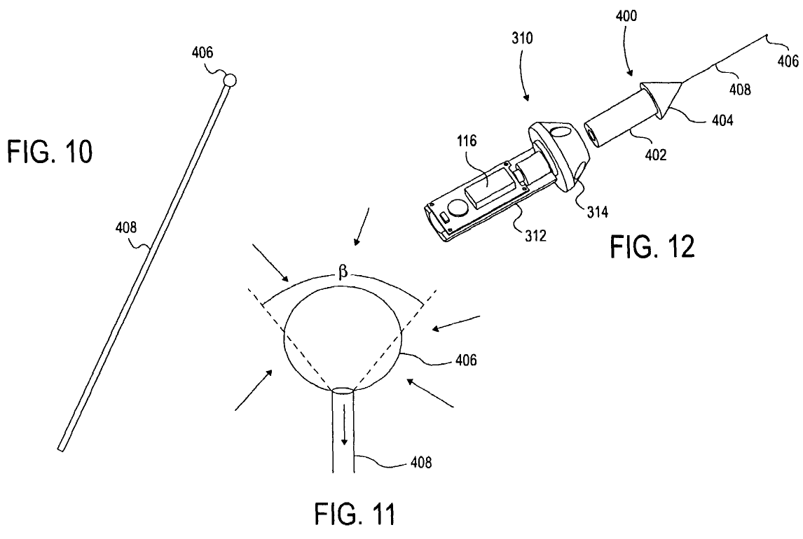

FIG. 10 is a detailed view of the iso-crystal 406 and the optical fiber 408. The iso-crystal 406 and optical fiber 408 may be molded, machined and/or extruded, and the like as known to those of skill in the art. In one embodiment, iso-crystal 406 and optical fiber 408 are attached to one another with, for example, an epoxy.

In one embodiment, the optical fiber 408 and the iso-crystal 406 have a unitary construction. The iso-crystal 406 and the optical fiber 408 may be formed from the same material. For example, the iso-crystal and optical fiber may both be made of PMMA. As discussed above, because PMMA does not scatter light as well as some other materials, the PMMA iso-crystal should be coated or the outer surface should be altered so that it has light-scattering surface properties.

FIG. 11 is a schematic view of the optical fiber 408 and the iso-crystal 406. Light from various directions and at various intensities from the radiation source 102 contacts the iso-crystal 406. The light scatters when it contacts the iso-crystal 406. As explained above, the iso-crystal 406 may be made from a light-scattering material, coated with a light-reflecting dielectric coating, altered to have light-scattering surface properties, or combinations thereof. The iso-crystal 406 is capable of capturing light from virtually any direction and is, therefore, substantially omni-directional.

The optical fiber has a gathering angle β, which is the angle at which the base of the optical fiber can detect light. The captured light within the gathering angle α is transmitted through the optical fiber to the target detector 116 (not shown), as described hereinafter. In one embodiment, the gathering angle β of the optical fiber 408 is any angle or range of angles between approximately 220° and 240°. Alternatively, the gathering angle β of the optical fiber 408 may be less than 220° or greater than 240°. For example, in one embodiment, the gathering angle β of the optical fiber 408 may be approximately 180°.

FIG. 12 is a schematic view illustrating a partial cross-sectional view of the cartridge 310 and holder 400. The cartridge 310 includes a shaft 312, a partially conical tip 314, and the target detector 116. The partially conical tip 314 includes an opening (not shown) corresponding to the shaft 402 of the holder 400. The shaft 402 of the holder 400, in which the fiber 408 and iso-crystal 406 are inserted, is insertable into the opening of cartridge 310. In one embodiment, the partially conical tip 314 of the cartridge 310 is shaped to correspond with the conical tip 404 of the holder 400.

FIG. 13 is a detailed view of the coupling between the cartridge 310 and the holder 400. The holder 400 is shown positioned in and removably secured to the cartridge 310, such that the iso-crystal 406 extends from the conical tip 404 of the holder 400. The optical fiber 408 is coupled to the target detector 116 of the cartridge 310 when the holder 400 is inserted into the cartridge 310 at an edge 316 of the printed circuit board 318 on which the detector 116 is positioned.

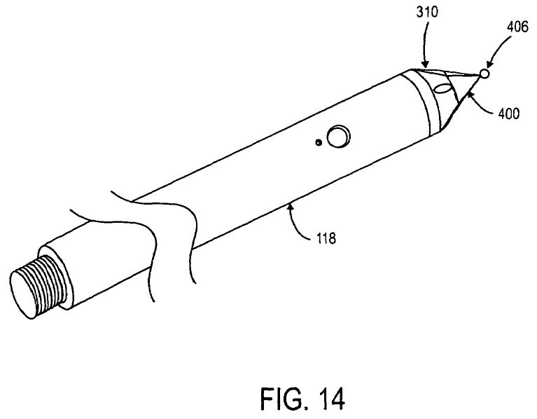

FIG. 14 is a perspective view illustrating the iso-post 1.18 with the cartridge 310 and holder 400 positioned in the iso-post 118. The cartridge 310 is inserted into the opening in the shaft 400 of the iso-post 118 and removably secured, such that the iso-crystal 406 is positioned at an end of the iso-post 118. The iso-post 118 is coupled to the QA processing system 114. Thus, light captured by the iso-crystal 406 and transmitted by the optical fiber 408 to the target detector 116 can be processed and analyzed by the QA processing system 114 to determine whether the radiation treatment delivery system 100 (or 200) is calibrated and/or aligned.

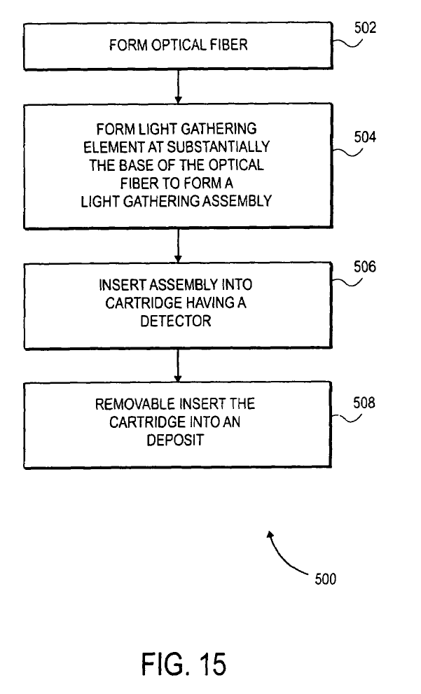

FIG. 15 is a flow diagram box showing a method 500 of making a replaceable iso-crystal cartridge in accordance with one embodiment of the invention. The method 500 begins at block 502 where the optical fiber, such as optical fiber 408, is formed. In one embodiment, the optical fiber is extruded or molded. Other methods for forming the fiber as known to those of skill in the art may be used.

The method continues by forming the light gathering element, such as iso-crystal 406, at substantially the base of the optical fiber (block 504). It will be appreciated by those of skill in the art that the light gathering element can be formed prior to, subsequent, or concurrent with formation of the optical fiber.

The light gathering element has an outer surface, which has a first portion and a second portion. The first portion of the outer surface of the light gathering element is positioned at substantially the base of the fiber, and the second portion of the light gathering element is substantially omni-directional. The light gathering element and optical fiber together form a light gathering assembly. In one embodiment, the ends of the optical fiber are cleaned and/or otherwise prepared for light transmission, as known to those of skill in the art.

In one embodiment, the light gathering element is also extruded or molded. In another embodiment, the light gathering element is machined and/or molded separate from the optical fiber and attached to the fiber with, for example, an epoxy. Other materials or processes may be used to attach the optical fiber and the light gathering element. In one embodiment, the light gathering element and optical fiber are a unitary construction.

At block 506, the light gathering assembly is inserted into a cartridge having a detector. As explained above, the light gathering assembly may optionally be placed into a holder, such as holder 400, which is subsequently removably placed into the cartridge, such as cartridge 310. In one embodiment, the cartridge and/or holder are made from a plastic, such as, for example, DELRIN®. It will be appreciated that other plastic or non-plastic materials may be used to make the cartridge and/or holder.

At block 508, the cartridge is removably inserted into the iso-post. As explained above with reference to FIGS. 13 and 14, the holder 400 is removably inserted into the cartridge 310, which is removably inserted into the opening in the shaft 300 of the iso-post 118.

Thus, the holder and/or cartridge can be replaced without replacing the entire iso-post 118, which minimizes the requirement of expert field service personnel to replace the light gathering element. In addition, because the iso-crystal is substantially spherical and made from different materials than the prior art iso-crystals, the radiation treatment delivery system does not necessarily need to be re-calibrated when the iso-crystal is replaced.

It should be noted that the methods and apparatus described herein are not limited to use only with medical diagnostic imaging and treatment. In alternative embodiments, the methods and apparatus herein may be used in applications outside of the medical technology field, such as industrial imaging and non-destructive testing of materials (e.g., motor blocks in the automotive industry, airframes in the aviation industry, welds in the construction industry and drill cores in the petroleum industry) and seismic surveying. In such applications, for example, “treatment” may refer generally to the application of radiation beam(s).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. A light gathering apparatus comprising:
a light gathering element having an outer surface, the outer surface having a first portion and a second portion, the second portion of the light gathering element being substantially omni-directional; and
an optical fiber having a base, wherein the first portion of the outer surface of the light gathering element is coupled to the optical fiber at substantially the base.

2. The apparatus of claim 1, wherein the light gathering element is coupled to the optical fiber at the base.

3. The apparatus of claim 1, wherein the light gathering element is coupled to the optical fiber at substantially the base comprises a portion of the optical fiber extending into the light gathering element, the portion of the optical fiber extending into the light gathering element being less than approximately a diameter of the optical fiber.

4. The apparatus of claim 1, wherein the light gathering element is coupled to the optical fiber at substantially the base comprises a portion of the optical fiber extending into the light gathering element, the portion of the optical fiber extending into the light gathering element being less than approximately 1% of the diameter of the fiber.

5. The apparatus of claim 1, wherein the optical fiber is configured to be coupled with a detector to form an integrated light gathering assembly to transmit light from a radiation source to the detector.

6. The apparatus of claim 1, wherein the light gathering element is to scatter light from the radiation source and the optical fiber is to transmit the scattered light to a detector.

7. The apparatus of claim 6, wherein the light gathering element comprises a dielectric coating.

8. The apparatus of claim 6, wherein the light gathering element is formed from polymethylmethacrylate (PMMA).

9. The apparatus of claim 8, wherein the light gathering element comprises a dielectric coating.

10. The apparatus of claim 6, wherein the light gathering element is formed from polytetrafluoroethylene.

11. The apparatus of claim 6, wherein the light gathering element is formed from ruby.

12. The apparatus of claim 6, wherein the light gathering element is formed from a polymer.

13. The apparatus of claim 6, wherein the light gathering element has a light-scattering surface.

14. The apparatus of claim 13, wherein the outer surface of the light gathering element is altered to have light-scattering surface properties.

15. The apparatus of claim 1, wherein the light gathering element and the optical fiber have a unitary construction.

16. The apparatus of claim 15, wherein the light gathering element and the optical fiber are formed from the same material.

17. The apparatus of claim 1, wherein the light gathering element is substantially spherical.

18. The apparatus of claim 1, wherein the light gathering element comprises a wave length conversion material.

19. The apparatus of claim 1, wherein the light gathering element has a diameter of about 2 mm.

20. A detector assembly for a radiation treatment delivery system comprising:
a cartridge having an opening therein;
a light gathering element having an outer surface and positioned at an end of the cartridge;
an optical fiber coupled to the outer surface of the light gathering element, the optical fiber positioned in the opening of the cartridge; and
a detector, coupled with the optical fiber, in the cartridge.

21. The detector assembly of claim 20, further comprising an iso-post, the cartridge being disposed in the iso-post.

22. The detector assembly of claim 20, further comprising a support to position the detector assembly near a center of an image guidance system of the radiation delivery treatment system, wherein the cartridge is disposed in the support.

23. The detector assembly of claim 20, wherein the light gathering element is to scatter light and the optical fiber is to transmit the light scattered by the light gathering element to the detector.

24. The detector assembly of claim 23, wherein the light gathering element comprises a dielectric coating.

25. The detector assembly of claim 23, wherein the light gathering element has a light-scattering surface.

26. The detector assembly of claim 25, wherein the outer surface of the light gathering element is altered to have light-scattering surface properties.

27. The detector assembly of claim 20, wherein the light gathering element is substantially omni-directional.

28. A method of manufacturing a light gathering apparatus comprising:
forming an optical fiber having a base; and
forming a light gathering element at substantially the base of the optical fiber, the light gathering element having an outer surface having a first portion and a second portion, wherein the first portion of the outer surface of the light gathering element is positioned at substantially the base of the fiber, the second portion of the light gathering element being substantially omni-directional.

29. The method of claim 28, further comprising positioning the assembly into a cartridge having an opening to receive the optical fiber, the light gathering element extending from an end of the cartridge.

30. The method of claim 29, wherein the cartridge comprises a shaft and a conical tip at the end of the shaft, the light gathering element extending from the conical tip.

31. The method of claim 28, wherein forming the integrated light gathering assembly comprises extruding or molding the optical fiber and light gathering element.

32. The method of claim 28, wherein forming the integrated light gathering assembly comprises machining.

33. The method of claim 28, further comprising coating the light gathering element with a light-scattering material.

34. The method of claim 28, further comprising altering a surface of the light gathering element to have light-scattering properties.

35. The method of claim 28, further comprising adhering the outer surface of the light gathering element to the optical fiber with an epoxy.

36. The method of claim 28, wherein the light gathering element and the optical fiber are formed from the same material.

37. The method of claim 28, wherein the light gathering element comprises polymethylmethacrylate (PMMA).

38. The method of claim 28, wherein the light gathering element comprises polytetrafluoroethylene.

39. The method of claim 28, wherein the light gathering element comprises ruby.

40. The method of claim 28, wherein the light gathering element comprises a polymer.
